(19) United States
(12) Patent Application Publication
(10) Pub. No.: US 2012/0000076 A1
(43) Pub. Date: Jan. 5, 2012

(54) COLOR AND CUT CRAFT SCISSORS SYSTEMS

(76) Inventors: Robyn Seifert, Norwood, NY (US); Richard Seifert, JR., Norwood, NY (US)

(21) Appl. No.: 13/165,949

(22) Filed: Jun. 22, 2011

Related U.S. Application Data
(60) Provisional application No. 61/359,898, filed on Jun. 30, 2010.

(51) Int. Cl. B26B 13/22

(52) U.S. Cl. 30/123.3

(57) ABSTRACT

A device for simultaneously cutting and coloring a craft item which comprises a first cutting blade having a first handle, a set of apertures, an outside inclined surface and an inside planar surface; a second cutting blade having a second handle; a reservoir containing a coloring substance; a coloring-substance-distributor; and at least one connection tube in communication with the set of apertures, the reservoir and the coloring-substance-distributor. The first cutting blade is pivotally mounted relative to the second cutting blade. The reservoir and the coloring-substance-distributor are connected via the connection tube which communicates the coloring substance such that the coloring substance may be deposited on the craft item during a cutting activity. The coloring-substance-distributor is activated via sliding the first cutting blade and the second cutting blade against each other and creating a wicking capillary movement of the coloring substance onto the craft item.

### CROSS-REFERENCE TO RELATED APPLICATION

The present application is related to and claims priority from prior provisional application Ser. No. 61/359,898, filed Jun. 30, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of scissors and more specifically relates to a device for simultaneously cutting and coloring a craft item.

### 2. DESCRIPTION OF THE RELATED ART

Making your own arts and crafts is an excellent way to both express yourself creatively and at the same time produce decorative items. There is a wide variety of crafts that people may enjoy making. Whether it is a special craft project for a birthday party, decorating a home with handmade items, creating jewelry, or making holiday decorations, people enjoy being creative and using their imagination to complete fun projects.

Paper crafts, such as making greeting cards, gift wrap, or party invitations have become increasingly popular, especially when it comes to arts and craft projects which can be performed at home. An additional benefit is that craft projects may help to keep children occupied. People who enjoy arts and crafts are always looking for new tools to add to their collection. Many individuals enjoy using different kinds of scissors to add creativity to their project. Pinking shears, for example, create a wavy edge on cut objects, which has more character than a straight edge. People that enjoy crafts appreciate anything that adds originality and uniqueness.

Scissors are commonly used for paper crafts and other craft projects. Unfortunately, most scissors only have one function, which is to cut an item. Therefore a need exists for scissors which have more than one function and which may be used to simultaneously cut and color an item so as to add more variety and uniqueness to craft projects.

Various attempts have been made to solve the above-mentioned problems such as those found in U.S. Pat. Nos. 6,523,264, 4,891,882, 4,783,907, 3,107,425, 2,826,859, and 643,377. This prior art is representative of scissors. None of the above inventions and patents, taken either singly or in combination, is seen to describe the invention as claimed.

Ideally, a device for simultaneously cutting and coloring material should require little maintenance, be easy to use, and, yet, would operate reliably and be manufactured at a modest expense. Thus, a need exists for a reliable device for simultaneously cutting and coloring material and to avoid the above-mentioned problems.

### BRIEF SUMMARY OF THE INVENTION

In view of the foregoing disadvantages inherent in the known scissors art, the present invention provides a novel Color and Cut Craft Scissors System. The general purpose of the present invention, which will be described subsequently in greater detail, is to provide a device for simultaneously cutting and coloring a craft item.

The device for simultaneously cutting and coloring a craft item disclosed herein preferably comprises the following components: a first cutting blade having a first handle, a set of apertures, an outside inclined surface and an inside planar surface; a second cutting blade having a second handle; a reservoir containing a coloring substance; a coloring-substance-distributor; and at least one connection tube in communication with the set of apertures, the reservoir and the coloring-substance-distributor.

The first cutting blade is pivotally mounted relative to the second cutting blade. The reservoir is affixed to the outside inclined surface of the first cutting blade and contains the coloring substance. The coloring-substance-distributor is integral with the inside planar surface of the first cutting blade. The reservoir and the coloring-substance-distributor are connected via the connection tube which communicates the coloring substance through the set of apertures such that the coloring substance may be deposited on the craft item during a cutting activity. The coloring-substance-distributor is activated via sliding the first cutting blade and the second cutting blade against each other and creating a wicking capillary movement of the coloring substance onto the craft item.

A kit is also described herein including the device for simultaneously cutting and coloring a craft item, at least one reservoir filled with the coloring substance, at least one coloring-substance-distributor, and a set of user instructions.

In accordance with the embodiments of the present invention a preferred method of use is disclosed herein comprising: attaching a full reservoir containing a coloring substance to an outside inclined surface of a first cutting blade of a pair of scissors; connecting the reservoir to a coloring-substance-distributor which is integral with an inside planar surface of the first cutting blade via at least one connection tube; activating the coloring-substance-distributor via cutting the craft item and sliding the first cutting blade and a second cutting blade against each other; and thereby creating a colored border along the cut material.

The present invention holds significant improvements and serves as a Color and Cut Craft Scissors System. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Color and Cut Craft Scissors System, constructed and operative according to the teachings of the present invention.

FIG. 1 shows a perspective view illustrating a device for simultaneously cutting and coloring a craft item according to an embodiment of the present invention.

FIG. 2 is a perspective view illustrating the device for simultaneously cutting and coloring a craft item according to an embodiment of the present invention of FIG. 1.

FIG. 3 is a perspective view illustrating the device for simultaneously cutting and coloring a craft item in an in-use condition according to an embodiment of the present invention of FIGS. 1 and 2.

FIG. 4 is a perspective view illustrating the device for simultaneously cutting and coloring a craft item according to another embodiment of the present invention.

FIG. 5 is a flowchart illustrating a method of use according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to the field of scissors and more particularly to a device for simultaneously cutting and coloring a craft item as used to create a colored border along cut material.

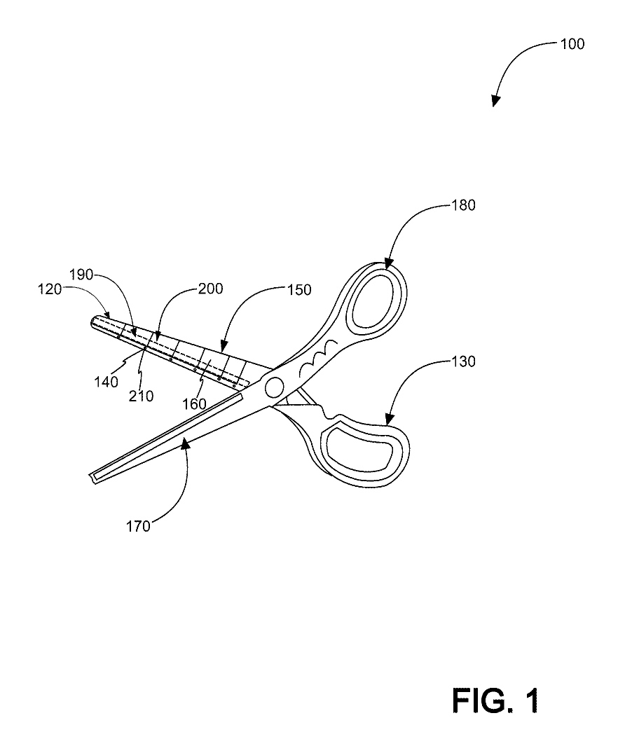

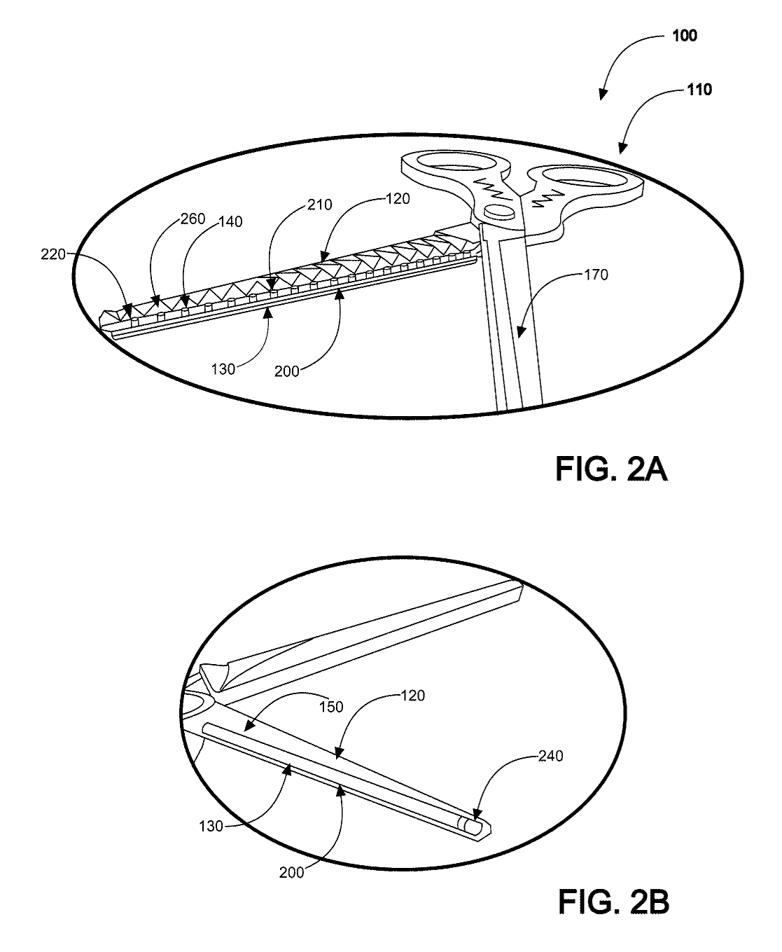

Referring to the drawings by numerals of reference there is shown in FIGS. 1 and 2, a perspective view illustrating a device for simultaneously cutting and coloring a craft item 110 according to an embodiment of the present invention.

Device for simultaneously cutting and coloring a craft item 110 disclosed herein preferably comprises the following components: first cutting blade 120 having first handle 130, set of apertures 140, outside inclined surface 150 and inside planar surface 160; second cutting blade 170 having second handle 180; reservoir 190 containing coloring substance 200; coloring-substance-distributor 210; and at least one connection tube 220 in communication with set of apertures 140, reservoir 190 and coloring-substance-distributor 210.

First cutting blade 120 is pivotally mounted relative to second cutting blade 170, a common method for assembling scissors. First cutting blade 120 comprises first handle 130, set of apertures 140, outside inclined surface 150 and inside planar surface 160. First cutting blade 120 and second cutting blade 170 may be saw-toothed or straight or may have various shapes so as to produce various cutting designs such as postage stamp borders, wavy line borders, etc. First cutting blade 120 and second cutting blade 170 preferably comprise a length of five inches to seven inches. Set of apertures 140 preferably comprises a set of 15-20 small holes (depending on the cutting design) which are situated in a linear array along the entire length of first cutting blade 120. Second cutting blade 170 comprises second handle 180. First handle 130 and second handle 180 preferably comprise colored plastic. First handle 130 and second handle 180 may have the cutting design displayed for ease of choosing the desired design.

Reservoir 190 is affixed to outside inclined surface 150 of first cutting blade 120 and contains coloring substance 200. Reservoir 190 preferably comprises a translucent tube which is preferably made of clear plastic so as to allow user to easily check the color and level of coloring substance 200. Reservoir 190 preferably comprises cap 240 to containably hold coloring substance 200. Reservoir 190 is preferably removably attached to outside inclined surface 150 of first cutting blade 120 for quick-exchanging when reservoir 190 is empty of coloring substance 200. Coloring substance 200 preferably comprises ink or craft paint. However, coloring substance 200 may comprise any suitable coloring substance 200.

As previously mentioned, device for simultaneously cutting and coloring a craft item 110 disclosed herein comprises coloring-substance-distributor 210. Coloring-substance-distributor 210 is situated at inside planar surface 160 of first cutting blade 120. Reservoir 190 and coloring-substance-distributor 210 are connected via connection tube 220 which communicates coloring substance 200 from reservoir 190 through apertures 140 to coloring-substance-distributor 210 which is integral with inside planar surface 160 of first cutting blade 120.

Connection tube 220 may comprise a multitude of connection tubes 220 which are removably attached along the length of reservoir 190. Connection tubes 220 pass through a multitude of apertures 140 situated along first cutting blade 120 and connect reservoir 190 and coloring-substance-distributor 210, wherein reservoir 190 delivers coloring substance 200 to connection tubes 220 in a parallel relationship. In this way coloring substance 200 is transferred from reservoir 190 situated at outside inclined surface 150 through set of apertures 140 to coloring-substance-distributor 210 situated at inside planar surface 160. Connection tube 220 is connected to reservoir 190 via a series of connectors which comprise one way valves to ensure proper directional flow of the ink.

In an alternative embodiment, connection tube 220 may be single connection tube 220 which is removably attached to one end of reservoir 190. Single connection tube 220 may divide up into a multitude of additional connection tubes 220 passing through a multitude of apertures 140 situated along first cutting blade 120 and connecting reservoir 190 and coloring-substance-distributor 210, wherein reservoir 190 provides coloring substance 200 to connection tubes 220 in a consecutive series relationship.

Coloring-substance-distributor 210 preferably comprises opening 260 at the end of connection tube 220. Connection tube 220 transfers coloring substance 200 from reservoir 190 through apertures 140 to opening 260 at end of connection tube 220. End of the connection tube 220 is integral to and attached to inside planar surface 160 of first cutting blade 120. Connection tube 220 transfers coloring substance 200 via capillary action such that coloring substance 200 may be deposited on craft item 230 during a cutting activity. The distribution of the coloring substance 200 is activated via sliding first cutting blade 120 and second cutting blade 170 adjacently-proximate each other and thereby creating a wicking capillary movement of the coloring substance 200 into craft item 230.

In an alternative embodiment coloring-substance-distributor 210 may comprise a mechanical applier such as a felt tip. Coloring-substance-distributor 210 may comprise an elongated flat felt tip which may preferably be affixed to the entire length of inside planar surface 160 of first cutting blade 120 and be connected to reservoir 190 via a multitude of connection tubes 220 which transfer coloring substance 200 through apertures 140. Connection tube 220 and the felt tip transfer coloring substance 200 via capillary action such that the coloring substance 200 may be deposited on the craft item 230 during a cutting activity. Device for simultaneously cutting and coloring a craft item 110 may further comprise a lid which may fit snugly over first cutting blade 120 and second cutting blade 170 so as to prevent the felt tip from drying out.

In yet another alternative embodiment, connection tube 220 comprises inkjets 270 which are situated at the end of connection tube 220 and which are integral with inside planar surface 160 of first cutting blade 120. Inkjets 270 are activated via a plunger which may push into connection tube 220 as the scissors are cutting. Inkjets 270 comprise one-way valves. Another one-way valve is situated between reservoir 190 and connection tube 220. Device for simultaneously cutting and coloring a craft item 110 comprises a piston system that may operate with first handle 130 and second handle 180 to draw ink from reservoir 190 to connection tube 220 and then push it from connection tube 220 out inkjets 270 on to the paper. As the scissors are opened, a one-way valve may allow ink to be drawn from reservoir 190 to connection tube 220 and as they are closed, the valve situated between reservoir 190 and connection tube 220 closes, the valves on the inkjets 270 open and the piston/plunger forces the ink out the inkjets 270.

A small gear system that may utilize a connection to first handle 130 is used to activate the piston/plunger. Using the gear and piston system, as the scissors are opened, the plunger on the end of the piston may cause a vacuum in connection tube 220 which will draw ink from reservoir 190. As the scissors are closed, the plunger on the end of the piston may force pressure into connection tube 220 forcing the ink to spray out inkjets 270 onto the material being cut.

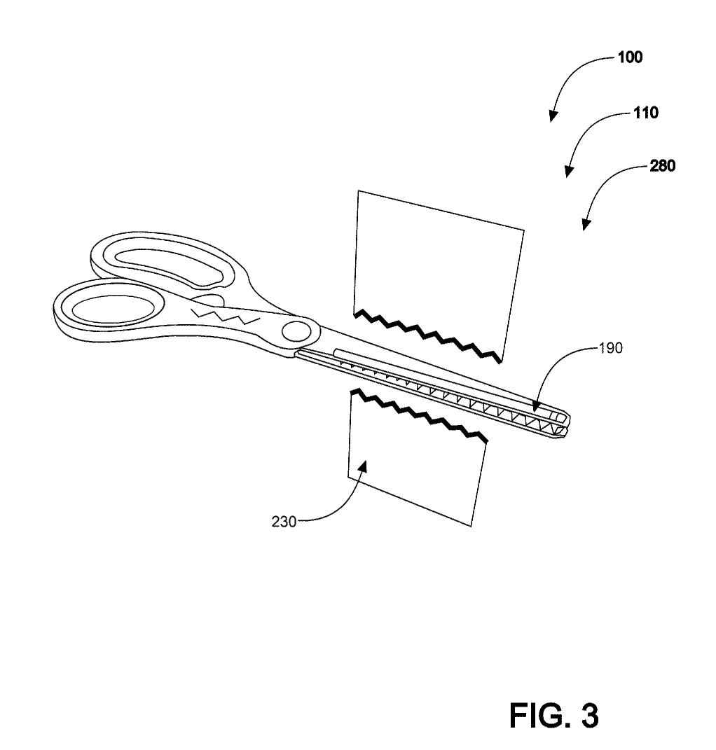

Referring now to FIG. 3, a perspective view illustrating device for simultaneously cutting and coloring a craft item 110 in ‘in-use’ condition 280 according to an embodiment of the present invention of FIGS. 1 and 2.

Connection tube 220 delivers coloring substance 200 from reservoir 190 to opening 260 at end of the connection tube 220. Opening 260 at the end of connection tube 220 communicates coloring substance 200 via capillary action such that coloring substance 200 may be deposited on the craft item 230 during a cutting activity.

In an alternate embodiment, the felt tip at the end of connection tube 220 communicates coloring substance 200 via capillary action such that coloring substance 200 may be deposited on craft item 230 during a cutting activity. The distribution of coloring substance 200 is activated via sliding first cutting blade 120 and second cutting blade 170 adjacently-proximate each other and thereby creating a wicking capillary movement of coloring substance 200 into craft item 230.

In yet another alternate embodiment, inkjets 270 which are situated at the end of connection tube 220 near inside planar surface 160 of scissors distribute coloring substance 200 on the craft item 230 during a cutting activity.

FIG. 3 depicts a device for simultaneously cutting and coloring a craft item 110, and craft item 230 after a cutting activity which has a colored edge along the cut area.

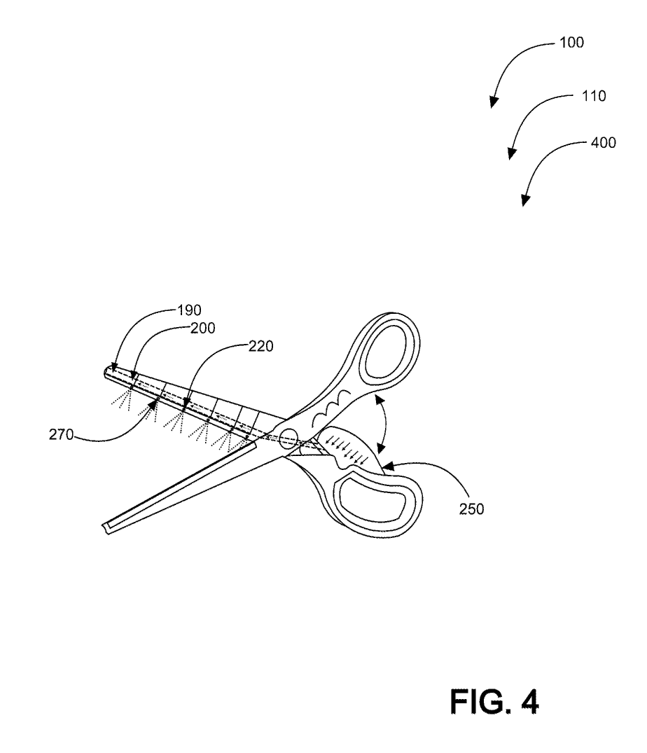

Referring now to FIG. 4, a perspective view illustrating the device for simultaneously cutting and coloring a craft item 110 according to another embodiment of the present invention.

FIG. 4 depicts an alternative embodiment of the device for simultaneously cutting and coloring a craft item 110 comprising inkjets 270. Device for simultaneously cutting and coloring a craft item 110 further comprises cooperative pump 250 which supports the wicking capillary action.

Cooperative pump 250 may comprise a small bladder air pump which may be situated between first handle 130 and second handle 180, utilizing unidirectional valves, such that opening scissors lets air into the bladder, inflating it, and closing scissors (cutting) deflates the bladder. Cooperative pump 250 is preferably connected to reservoir 190 via an air tube which comprises a valve so as to allow unidirectional flow of air from cooperative pump 250 to reservoir 190. Cooperative pump 250 enables pumping of pressurized air and forces coloring substance 200 to evacuate to a lower pressure, the lower pressure being located outside the inkjets 270 at the end of the connection tubes 220. Cooperative pump 250 provides a sufficient atomizing pressure upon coloring substance 200 so that coloring substance 200 may exit reservoir 190 through connection tubes 220 and inkjets 270.

Color and Cut Craft Scissors System 100 may be sold as kit 400 comprising the following parts: at least one device for simultaneously cutting and coloring a craft item 110, at least one reservoir 190 filled with coloring substance 200, at least one coloring-substance-distributor 210, and a set of user instructions. Color and Cut Craft Scissors System 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

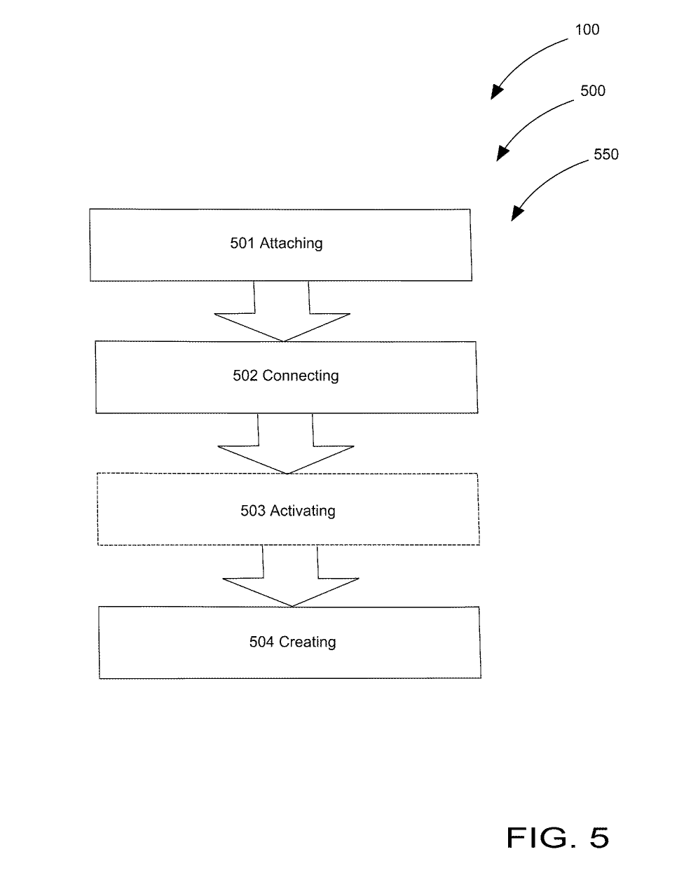

Referring now to FIG. 5, a flowchart 550 illustrating method of use 500 according to an embodiment of the present invention of FIG. 1.

In accordance with the embodiments of the present invention a preferred method of use 500 is disclosed herein comprising: step one 501 attaching a full reservoir 190 containing a coloring substance 200 to an outside inclined surface 150 of a first cutting blade 120 of a pair of scissors; step two 502 connecting reservoir 190 to coloring-substance-distributor 210 which is integral with inside planar surface 160 of first cutting blade 120 via a least one connection tube 220; step three 503 activating coloring-substance-distributor 210 via cutting craft item 230 and sliding first cutting blade 120 and second cutting blade 170 against each other; and step four 504 thereby creating a colored border along the cut material.

It should be noted that the steps described in the method of use 500 can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for simultaneously cutting and coloring a craft item comprising:
a first cutting blade having a first handle, a set of apertures, an outside inclined surface and an inside planar surface;
a second cutting blade having a second handle;
a reservoir containing a coloring substance;
a coloring-substance-distributor; and
at least one connection tube in communication with said set of apertures, said reservoir and said coloring-substance-distributor;
wherein said first cutting blade is pivotally mounted relative to said second cutting blade;
wherein said reservoir is affixed to said outside inclined surface of said first cutting blade and said reservoir contains said coloring substance;
wherein said coloring-substance-distributor is integral with said inside planar surface of said first cutting blade;
wherein said reservoir and said coloring-substance-distributor are connected via said connection tube which communicates said coloring substance such that said coloring substance may be deposited on said craft item during a cutting activity; and
wherein said coloring-substance-distributor is activated via sliding said first cutting blade and said second cutting blade against each other, creating a wicking capillary movement of said coloring substance onto said craft item.

2. The device for simultaneously cutting and coloring a craft item of claim 1 wherein said first handle and said second handle comprise colored plastic.

3. The device for simultaneously cutting and coloring a craft item of claim 2 wherein said colored plastic displays the cutting design of the scissors.

4. The device for simultaneously cutting and coloring a craft item of claim 1 wherein said reservoir comprises a translucent tube with a cap which containably-holds said coloring substance.

5. The device for simultaneously cutting and coloring a craft item of claim 1 wherein said reservoir comprises clear plastic.

6. The device for simultaneously cutting and coloring a craft item of claim 1 wherein said reservoir is removably attached to said outside inclined surface of said first cutting blade for quick-exchanging when said reservoir is empty of said coloring substance.

7. The device for simultaneously cutting and coloring a craft item of claim 1 wherein said coloring substance comprises ink.

8. The device for simultaneously cutting and coloring a craft item of claim 1 wherein said coloring substance comprises craft paint.

9. The device for simultaneously cutting and coloring a craft item of claim 1 wherein said wicking capillary movement is supplemented by a cooperative pump.

10. The device for simultaneously cutting and coloring a craft item of claim 9 wherein said cooperative pump enables pumping of pressurized air and forces said coloring substance to evacuate to a lower pressure, said lower pressure being located outside said apertures.

11. The device for simultaneously cutting and coloring a craft item of claim 9 wherein said cooperative pump provides an atomizing sufficient pressure upon said coloring substance.

12. The device for simultaneously cutting and coloring a craft item of claim 1 wherein said coloring-substance-distributor comprises an opening at the end of said connection tube.

13. The device for simultaneously cutting and coloring a craft item of claim 1 wherein said coloring-substance-distributor comprises a felt tip.

14. The device for simultaneously cutting and coloring a craft item of claim 9 wherein said coloring-substance-distributor comprises an inkjet.

15. The device for simultaneously cutting and coloring a craft item of claim 1 wherein said at least one connection tube comprises a through channel.

16. The device for simultaneously cutting and coloring a craft item of claim 1 wherein a multitude of said connection tubes are removably attached along the length of said reservoir, said connection tubes communicating to a multitude of said apertures situated along said first cutting blade and connecting said reservoir and said coloring-substance-distributor, wherein said reservoir provides said coloring substance to said connection tubes in a parallel relationship.

17. The device for simultaneously cutting and coloring a craft item of claim 1 wherein said one connection tube is removably attached to one end of said reservoir, said one connection tube dividing up into a multitude of additional said connection tubes communicating to a multitude of said apertures situated along said first cutting blade and connecting said reservoir and said coloring-substance-distributor, wherein said reservoir provides said coloring substance to said connection tubes in a consecutive series relationship.

18. A device for simultaneously cutting and coloring a craft item comprising:
a first cutting blade having a first handle comprising colored plastic, a set of apertures, an outside inclined surface and an inside planar surface;
a second cutting blade having a second handle comprising colored plastic;
a reservoir comprising a translucent plastic tube with a cap containing a coloring substance which is removably attached to said outside inclined surface of said first cutting blade for removably quick-exchanging when empty;
at least one connection tube; and
a coloring-substance-distributor comprising an opening at the end of said connection tube;
wherein said first cutting blade is pivotally mounted relative to said second cutting blade;
wherein said reservoir is affixed to said outside inclined surface of said first cutting blade and contains said coloring substance;
wherein a multitude of said connection tubes are removably attached along the length of said reservoir, said connection tubes communicating to a multitude of said apertures situated along said first cutting blade, wherein said reservoir provides said coloring substance to said connection tubes in a parallel relationship;
wherein said coloring-substance-distributor comprises an opening at the end of said connection tube which is integral with said inside planar surface of said first cutting blade;
wherein said reservoir is connected to said connection tube which communicates said coloring substance such that said coloring substance may be deposited on said craft item during a cutting activity; and
wherein said coloring-substance-distributor is activated via sliding said first cutting blade and said second cutting blade adjacently-proximate each other, creating a wicking capillary movement of said coloring substance into said craft item.

19. The device for simultaneously cutting and coloring a craft item of claim 18 further comprising a kit including said device for simultaneously cutting and coloring a craft item, said at least one reservoir filled with said coloring substance, said at least one coloring-substance-distributor, and a set of user instructions.

20. A method for using a device for simultaneously cutting and coloring a craft item comprising the steps of:
attaching a full reservoir containing a coloring substance to an outside inclined surface of a first cutting blade of a pair of scissors;
connecting said reservoir to a coloring-substance-distributor which is integral with an inside planar surface of said first cutting blade via a least one connection tube;
activating said coloring-substance-distributor via cutting said craft item; and
thereby creating a colored border along the cut material.
